(19) United States
(12) Patent Application Publication
(10) Pub. No.: US 2013/0084882 A1
(43) Pub. Date: Apr. 4, 2013

(54) BECOMING MORE "AWARE" THROUGH USE OF CROWDSOURCING AND DEVICE INTERACTION

(71) Applicants: Behrooz Khorashadi, Mountain View, CA (US); Saumitra Mohan Das, San Jose, CA (US); Vidya Narayanan, San Diego, CA (US)

(72) Inventors: Behrooz Khorashadi, Mountain View, CA (US); Saumitra Mohan Das, San Jose, CA (US); Vidya Narayanan, San Diego, CA (US)

(73) Assignee: QUALCOMM INCORPORATED, San Diego, CA (US)

(21) Appl. No.: 13/251,062

(22) Filed: Sep. 30, 2011

(51) Int. Cl. H04W 4/02

(52) U.S. Cl. 455/456.1

(57) ABSTRACT

Techniques disclosed herein provide for assisted context determination through the use of one or more servers remote to a mobile device. The one or more servers can receive location and/or other information from the mobile device and select, from a list of possible activities, a smaller list of activities a mobile device user is likely engaged in. The one or more servers can return the smaller list to the mobile device, which can use the smaller list to make a faster context determination. In creating the smaller list, the one or more servers can utilize information regarding a region in which the mobile device is located, which can be updated and modified using information received from mobile devices. Furthermore, the one or more servers can gather and share information from nearby mobile devices, enabling a mobile device to use information from nearby mobile devices to facilitate a context determination.

### BACKGROUND OF THE INVENTION

Mobile devices are incredibly widespread in today's society. For example, people use cellular phones, smart phones, personal digital assistants, laptop computers, pagers, tablet computers, etc. to send and receive data wirelessly from countless locations. Moreover, advancements in wireless communication technology have greatly increased the versatility of today's wireless communication devices, enabling users to perform a wide range of tasks from a single, portable device that conventionally required either multiple devices or larger, non-portable equipment.

Mobile devices further can be configured to determine what activity a mobile device user may be engaged in through a process called context determination. Through context determination a mobile device can provide additional functionality to a mobile device user by adapting dynamically to the user's needs. For example, if a user enters a car, the mobile device can automatically enter a car mode; if the user enters a theater, the device can automatically enter a silent mode; etc. However, context determination can require a lot of processing power of the mobile device, which can reduce battery life. Furthermore, a context determination can be difficult for a mobile device with limited sensors or other input that could be indicative of an activity in which the mobile device user might be engaged.

### BRIEF SUMMARY OF THE INVENTION

Techniques disclosed herein provide for assisted context determination through the use of one or more servers remote to a mobile device. The one or more servers can receive location and/or other information from the mobile device and select, from a list of possible activities, a smaller list of activities a mobile device user is likely engaged in. The one or more servers can return the smaller list to the mobile device, which can use the smaller list to make a faster context determination. In creating the smaller list, the one or more servers can utilize information regarding a region in which the mobile device is located, which can be updated and modified using information received from mobile devices. Furthermore, the one or more servers can gather and share information from nearby mobile devices or mobile devices that previously visited the same locale, enabling a mobile device to use information from nearby mobile devices to facilitate a context determination.

An example of one or more servers for utilizing a data network to facilitate a determination of an activity related to a user of a mobile device, according to the disclosure, includes a communication interface communicatively coupled with the data network and configured to receive, from the mobile device, location information indicative of a location of the mobile device, a storage medium configured to store data indicative of a first plurality of activities, and an activity selection subsystem communicatively coupled with the storage medium and communication interface and configured to select, from the first plurality of activities, a second plurality of possible activities based on the location of the mobile device. The second plurality of possible activities comprises a subset of the first plurality of activities, and the data indicative of the second plurality of possible activities is sent to the mobile device via the communication interface.

The example of one or more servers for utilizing a data network to facilitate a determination of an activity related to a user of a mobile device can include one or more of the following features. The activity selection subsystem comprises one or more processors. The activity selection subsystem is configured to determine a rank for each activity of the second plurality of possible activities, where the rank for each activity of the second plurality of possible activities is indicative of a likelihood that the user of the mobile device is engaged in the activity, and provide the rank for each activity of the second plurality of possible activities to the mobile device. A database communicatively coupled with the activity selection subsystem and configured to store information defining one or more regions associated with the location of the mobile device. The activity selection subsystem is configured to select the second plurality of possible activities based, at least in part, on one or more activities associated with each of the one or more regions. The database is configured to store the one or more activities associated with each of the one or more regions. The activity selection subsystem is configured to determine a rank for each activity of the second plurality of possible activities, where the rank for each activity of the second plurality of possible activities is indicative of a likelihood that the user of the mobile device is engaged in the activity, the location of the mobile device is an approximate location that comprises an area in which the mobile device might be located, and the rank for the one or more activities associated with each of the one or more regions is based, at least in part, on a proximity of the one or more regions to a center of the area.

The example one or more servers for utilizing a data network to facilitate a determination of an activity related to a user of a mobile device further can include one or more of the following additional features. The one or more servers is configured to include, in the data indicative of the second plurality of possible activities, a unique identifier for each activity of the second plurality of possible activities that corresponds with an activity of the first plurality of activities. The mobile device comprises a first mobile device, and the communication interface is configured to receive activity information from one or more additional mobile devices, based, at least in part, on the location of the one or more additional mobile devices, and send, to the first mobile device, the activity information. The activity information includes at least one item from the list consisting of information from a sensor of the one or more additional mobile devices, information received from a user of the one or more additional mobile devices, and a computation regarding the activity related to the user of the one or more additional mobile devices. The communication interface is configured to receive activity information from the mobile device wherein the activity information includes at least one item from the list consisting of information from one or more sensors of the mobile device, information received from the user of the mobile device, and a computation regarding the activity related to the user of the mobile device. The activity selection subsystem is configured to make a determination regarding the activity related to the user of the mobile device. The activity selection subsystem is configured to modify a set of activities associated with a region in which the mobile device is located based, at least in part, on the determination regarding the activity related to the user of the mobile device.

An example method of facilitating a determination of an activity related to a user of a mobile device, according to the disclosure, includes receiving, from the mobile device, location information indicative of a location of the mobile device, selecting, from a first plurality of activities, a second plurality of possible activities based on the location of the mobile device. The second plurality of possible activities comprises a subset of the first plurality of activities. The example method further includes sending, to the mobile device, data indicative of the second plurality of possible activities.

The example method of facilitating a determination of an activity related to a user of a mobile device can include one or more of the following features. Determining a rank for each activity of the second plurality of possible activities, where the rank for each activity of the second plurality of possible activities is indicative of a likelihood that the user of the mobile device is engaged in the activity, and providing the rank for each activity of the second plurality of possible activities to the mobile device. Selecting the second plurality of possible activities further comprises identifying one or more regions associated with the location of the mobile device, and selecting the second plurality of possible activities based, at least in part, on one or more activities associated with each of the one or more regions. Determining a rank for each activity of the second plurality of possible activities, where the rank for each activity of the second plurality of possible activities is indicative of a likelihood that the user of the mobile device is engaged in the activity, the location of the mobile device is an approximate location that comprises an area in which the mobile device might be located, and the rank for the one or more activities associated with each of the one or more regions is based, at least in part, on a proximity of the one or more regions to a center of the area.

The example method of facilitating a determination of an activity related to a user of a mobile device also can include one or more of the following additional features. The data indicative of the second plurality of possible activities comprises a unique identifier for each activity of the second plurality of possible activities, and the unique identifier corresponds with an activity of the first plurality of activities. Receiving activity information from one or more additional mobile devices, based, at least in part, on the location of the one or more additional mobile devices, and sending, to the first mobile device, the activity information, where the activity information includes at least one item from the list consisting of information from a sensor of the one or more additional mobile devices, information received from a user of the one or more additional mobile devices, and a computation regarding the activity related to the user of the one or more additional mobile devices. The activity information from the one or more additional mobile devices includes sensor information from at least one type of sensor the first mobile device does not have. Receiving activity information from the mobile device wherein the activity information includes at least one item from the list consisting of information from one or more sensors of the mobile device, information received from the user of the mobile device, and a computation regarding the activity related to the user of the mobile device. Making a determination regarding the activity related to the user of the mobile device. Modifying a set of activities associated with a region in which the mobile device is located based, at least in part, on the determination regarding the activity related to the user of the mobile device.

An example computer program product residing on a non-transitory processor-readable medium and comprising processor-readable instructions, according to the disclosure, can be configured to cause a processor to receive, from a mobile device, location information indicative of a location of the mobile device, select, from a first plurality of activities, a second plurality of possible activities based on the location of the mobile device, wherein the second plurality of possible activities comprises a subset of the first plurality of activities, and send, to the mobile device, data indicative of the second plurality of possible activities.

The example computer program can be configured to include one or more of the following features. Determine a rank for each activity of the second plurality of possible activities, wherein the rank for each activity of the second plurality of possible activities is indicative of a likelihood that the a of the mobile device is engaged in the activity, and provide the rank for each activity of the second plurality of possible activities to the mobile device. Selecting the second plurality of possible activities further comprises identifying one or more regions associated with the location of the mobile device, and selecting the second plurality of possible activities based, at least in part, on one or more activities associated with each of the one or more regions. Determine a rank for each activity of the second plurality of possible activities, where the rank for each activity of the second plurality of possible activities is indicative of a likelihood that a user of the mobile device is engaged in the activity, the location of the mobile device is an approximate location that comprises an area in which the mobile device might be located, and the rank for the one or more activities associated with each of the one or more regions is based, at least in part, on a proximity of the one or more regions to a center of the area.

The example computer program further can be configured to include one or more of the following additional features. The data indicative of the second plurality of possible activities comprises a unique identifier for each activity of the second plurality of possible activities, and the unique identifier corresponds with an activity of the first plurality of activities. The mobile device comprises a first mobile device and the processor-readable instructions further are configured to cause the processor to receive activity information from one or more additional mobile devices, based, at least in part, on the location of the one or more additional mobile devices, and send, to the first mobile device, the activity information, where the activity information includes at least one item from the list consisting of information from a sensor of the one or more additional mobile devices, information received from a user of the one or more additional mobile devices, and a computation regarding the activity related to a user of the one or more additional mobile devices. The activity information from the one or more additional mobile devices includes sensor information from at least one type of sensor the first mobile device does not have. Receive activity information from the mobile device wherein the activity information includes at least one item from the list consisting of information from one or more sensors of the mobile device, information received from a user of the mobile device, and a computation regarding the activity related to the user of the mobile device. Make a determination regarding the activity related to the user of the mobile device. Modify a set of activities associated with a region in which the mobile device is located based, at least in part, on the determination regarding the activity related to the user of the mobile device.

An example one or more servers for facilitating a determination of an activity related to a user of a mobile device, according to the disclosure, can include means for receiving, via a network, location information indicative of a location of the mobile device means for selecting, from a first plurality of activities, a second plurality of possible activities based on the location of the mobile device, wherein the second plurality of possible activities comprises a subset of the first plurality of activities, and means for sending, to the mobile device, data indicative of the second plurality of possible activities.

The example one or more servers for facilitating a determination of an activity related to a user of a mobile device can include one or more of the following features. Means for determining a rank for each activity of the second plurality of possible activities, where the rank for each activity of the second plurality of possible activities is indicative of a likelihood that the user of the mobile device is engaged in the activity, and means for providing the rank for each activity of the second plurality of possible activities to the mobile device. The means for selecting the second plurality of possible activities further comprises means for identifying one or more regions associated with the location of the mobile device, and means for selecting the second plurality of possible activities based, at least in part, on one or more activities associated with each of the one or more regions. Means for determining a rank for each activity of the second plurality of possible activities, where the rank for each activity of the second plurality of possible activities is indicative of a likelihood that the user of the mobile device is engaged in the activity, the location of the mobile device is an approximate location that comprises an area in which the mobile device might be located, and the rank for the one or more activities associated with each of the one or more regions is based, at least in part, on a proximity of the one or more regions to a center of the area. The data indicative of the second plurality of possible activities comprises a unique identifier for each activity of the second plurality of possible activities, and the unique identifier corresponds with an activity of the first plurality of activities. The mobile device comprises a first mobile device, further comprising means for receiving activity information from one or more additional mobile devices, based, at least in part, on the location of the one or more additional mobile devices, and means for sending, to the first mobile device, the activity information, where the activity information includes at least one item from the list consisting of information from a sensor of the one or more additional mobile devices, information received from a user of the one or more additional mobile devices, and a computation regarding the activity related to the user of the one or more additional mobile devices.

The example one or more servers for facilitating a determination of an activity related to a user of a mobile device further can include one or more of the following additional features. The activity information from the one or more additional mobile devices includes sensor information from at least one type of sensor the first mobile device does not have. Means for receiving activity information from the mobile device wherein the activity information includes at least one item from the list consisting of information from one or more sensors of the mobile device, information received from the user of the mobile device, and a computation regarding the activity related to the user of the mobile device. Means for making a determination regarding the activity related to the user of the mobile device. Means for modifying a set of activities associated with a region in which the mobile device is located based, at least in part, on the determination regarding the activity related to the user of the mobile device.

Items and/or techniques described herein may provide one or more of the following capabilities, as well as other capabilities not mentioned. Reduction of power consumption of a mobile device by reducing the amount of processing to be done by context determination engine. Increased speed in context determination by focusing the effort of the context determination engine on the most likely states. Improved accuracy of context determination through learning of context states that occur most frequently in a location. While at least one item/technique-effect pair has been described, it may be possible for a noted effect to be achieved by means other than that noted, and a noted item/technique may not necessarily yield the noted effect.

### BRIEF DESCRIPTION OF THE DRAWINGS

FIG. 1 is a simplified diagram of a context determination system.

FIGS. 2A and 2B are illustrations of how a list of likely activities can be determined from a larger list of possible activities.

FIG. 3 is a simplified diagram of how a context assistance server can associate different locations with different activities through the use of geofencing.

FIG. 4 is a diagram illustrating how a context determination system can assist in context determination in instances where location of a mobile device may be imprecise.

FIG. 5 is a diagram illustrating how crowdsourced context information can be shared among mobile devices to help facilitate context determinations.

FIGS. 6A and 6B are simplified flow diagrams illustrating basic methods of facilitating context determination.

FIG. 7 is a swim-lane diagram that illustrates the interaction between components in a context determination system, according to one configuration.

FIG. 8 is an illustration of a computer system that may be incorporated in one or more components of the context determination system.

### DETAILED DESCRIPTION OF THE INVENTION

The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

Techniques are described herein for determining one or more activities a mobile device user might be engaged in, otherwise known as a context determination, which can enable a mobile device to provide additional functionality to the mobile device user. Such a context determination is facilitated through communication between the mobile device and a server. For example, the mobile device can send the server location and/or other information that server uses to determine a list of potential activities, which it provides to the mobile device. This list of potential activities can allow the mobile device to more easily determine the activity of the mobile device user, which can reduce the processing load and power consumption of the mobile device and increase the speed by which the determination is made. These and other techniques, are described in further detail below.

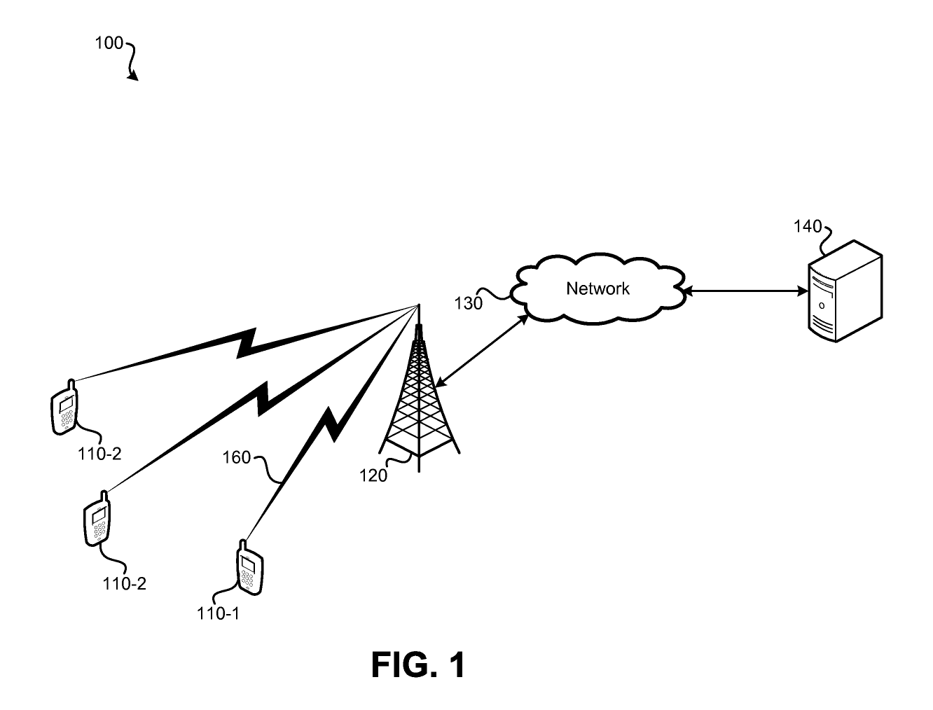

Configurations where data is collected from a mobile device to determine the activity, or context, of a mobile device user may be referred to as context determination systems. FIG. 1 illustrates a context determination system 100. The context determination system 100 includes: mobile devices 110, base station 120, network 130, and context assistance server 140. Mobile devices 110 can include mobile phones, tablet computers, personal digital assistants, or other wireless devices, which can communicate with a base station 120 using a wireless cellular connection 160. The wireless cellular connection 160 can include 2G, 3G, and/or 4G protocol, such as LTE (Long Term Evolution).

Base station 120 can be in communication with network 130. Network 130 can be one or more public and/or private data networks, such as the mobile carrier network, a local area network (LAN), and/or a wide area network (e.g., the Internet). Remote context assistance server 140, which can comprise one or more computing devices, can be in communication with network 130. Thus, information can be communicated between the mobile devices 110 and the context assistance server 140 via the base station 120 and the network 130.

The context determination system 100 can utilize the context assistance server 140 to help facilitate context determinations of mobile devices 110. For example, a first mobile device 110-1 can communicate information and/or other information to the context assistance server 140 that the context assistance server 140 can utilize to determine a list of the most likely activities in which the mobile device user is engaged. The context assistance server 140 can then communicate this list back to the first mobile device 110-1, which can use the list to make a context determination. As described in further detail below, information from other mobile devices 110-2 also can be used in a context determination of the first mobile device 110-1.

The information provided to the context assistance server 140 by a mobile device 110 can vary, depending on the functionality of the mobile device 110. For instance, a mobile device 110 may be equipped with a global positioning system (GPS) receiver, in which case the mobile device 110 can provide location information such as latitude, longitude, and elevation. Location information provided at multiple points in time can also be used to determine a direction and/or speed of travel. Additionally or alternatively, the mobile device 110 can include accelerometers and other orientation and/or movement sensors, which can be useful in determining certain activities that can be associated with certain movements (running, walking, sitting, etc.). In fact, modern mobile devices can include a variety of sensors capable of producing information that can be used for context determination. These sensors include, but are not limited to, microphones, cameras, proximity sensors, light detectors, temperature sensors, touch and/or pressure sensors, etc. Furthermore, mobile devices 110 may be communicatively coupled with additional sensors via wireless (e.g., Bluetooth™, IEEE 802.11, etc.) and/or wired connections that can provide additional information for a context determination.

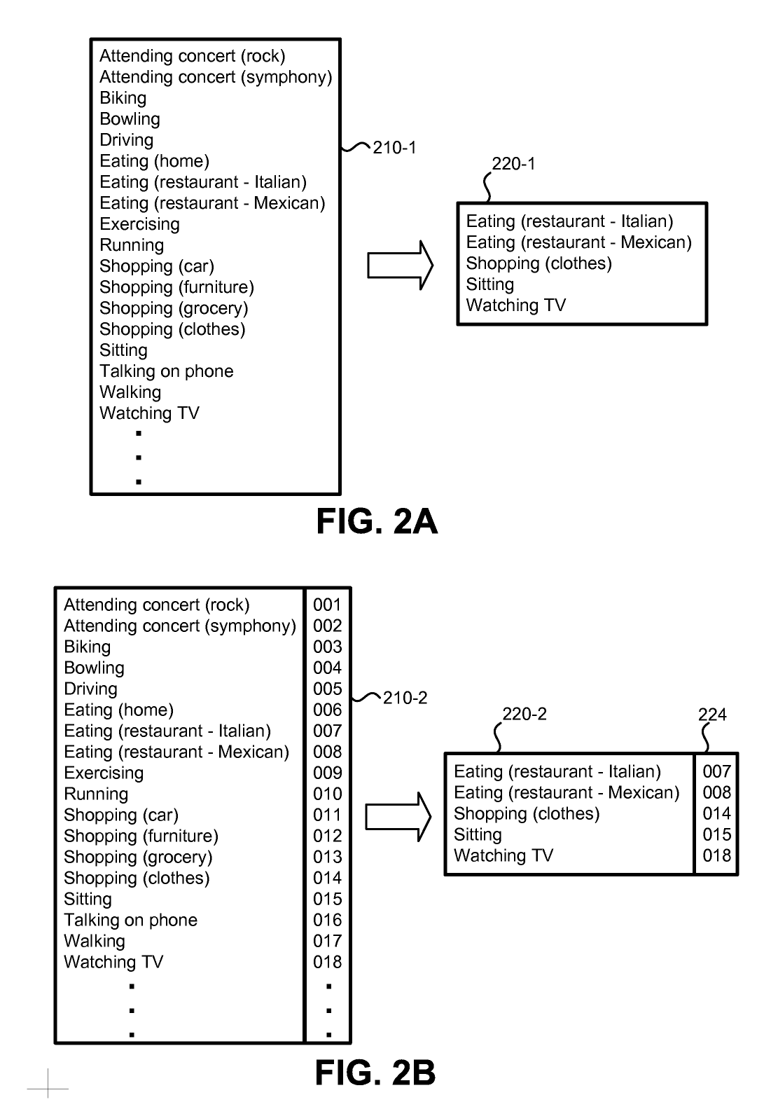

With the information provided by one or more mobile devices 110, the context assistance server 140 can determine and provide a list of likely activities in which the mobile device user may be engaged to a mobile device 110 making a context determination. FIG. 2A illustrates how the list of likely activities 220-1 can be determined from a larger list of possible activities 210-1. Depending on the desired granularity of activity type, the list of possible activities 210-1 can include dozens, hundreds, or more activities from which the list of likely activities 220-1 can be determined. For example, one configuration could include a list of possible activities 210-1 that includes “eating” as an activity, whereas more granular configurations may include eating a specific type of food and/or eating at a specific restaurant. The list of possible activities 210-1 can be stored in memory on the context assistance server 140 and/or stored in a database communicatively coupled with the context assistance server 140.

The list of likely activities 220-1 can be determined a variety of ways. The context assistance server 140 can, for example, use a process of elimination by which the context assistance server 140 creates the list of likely activities 220-1 by identifying activities in list of possible activities 210-1 that the mobile device user is unlikely to be engaged in, given the information provided by the mobile device 110 (e.g., location information, movement patterns, sounds, etc.), and selecting the activities that remain. Additionally or alternatively, the context assistance server 140 can create the list of likely activities 220-1 by identifying activities from list of possible activities 210-1 the mobile device user is likely engaged in, given the information provided by one or more mobile devices 110. Either way, the list of likely activities 220-1 includes a subset of the list of possible activities 210-1, which is provided to a mobile device 110 to facilitate the mobile device's ultimate determination of context.

FIG. 2B illustrates how activities can be indexed, thereby reducing the amount of information that needs to be communicated to a mobile device 110 for context determination. Instead of communicating the activities themselves, the context assistance server 140 can simply communicate unique identifiers—such as index numbers—that correspond to different activities on the list. For example, if both context assistance server 140 and mobile device 110 have an indexed list of possible activities 210-2, then after the context assistance server 140 creates the list of likely activities 220-2, it can simply return the list of identifiers 224 corresponding to the list of likely activities 220-2. The mobile device 110, after receiving the list of identifiers 224, then can recreate the list of likely activities 220-2 for a context determination.

It can be noted that a mobile device 110 can use the list of likely activities 220 in various ways to make a context determination. The mobile device 110, for example, can determine that the mobile device user is engaged in one or more activities on the list of likely activities 220. At other times and/or in other configurations, the mobile device 110 may determine that a mobile device user is engaged in all of the activities on the list of likely activities 220. At yet other times and/or in other configurations, the mobile device may determine that a mobile device user is not engaged in any activity on the list of likely activities 220, and may further determine that the mobile device user is engaged in one or more activities not on the list of likely activities 220.

As discussed above, the list of likely activities 220 for context determination can be determined by the context assistance server 140 from information received from the mobile device 110. Information regarding the location of the mobile device 110 can be particularly relevant in a context determination. Knowledge of the location of a mobile device 110 can rule in and/or out many activities in which the mobile device user might be engaged. For example, if it is determined that a mobile device 110 has been in a dining area of a shopping mall for several minutes, there is little likelihood that the mobile device is driving a car or bowling. On the other hand, there is a relatively high probability that the mobile device user is shopping and/or eating.

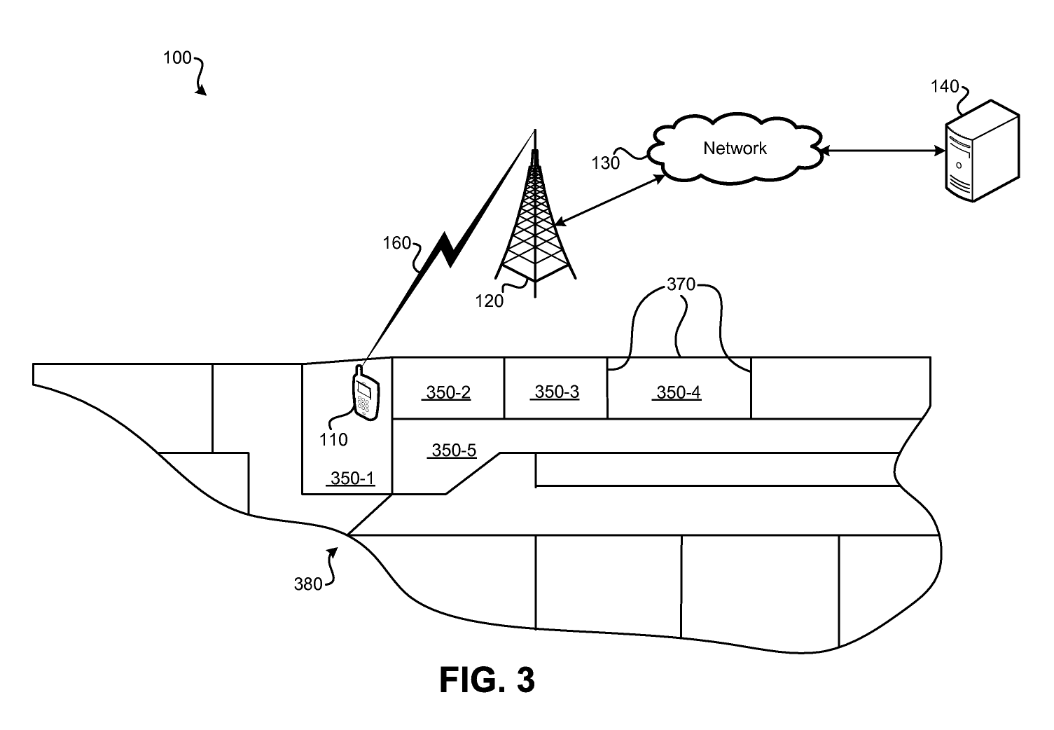

FIG. 3 is a simplified diagram of how a context assistance server 140 can associate different locations with different activities through the use of geofencing. Geofencing uses virtual perimeters 370 to divide a real-world geographic area 380 into numerous regions 350. The different regions 350 can be associated with different activities that are likely to be performed by a mobile device user within that region. Using the example above, if region 350-1 includes the dining area of a shopping mall, the region 350-1 may be associated with dining Furthermore, depending on factors such as the size of the region 350-1 and the granularity of the activity type, particular types of dining (e.g., deli, Italian food, Mexican food, etc.) can be associated with the region 350-1.

Activities associated within each region 350 and/or activities provided on the list of likely activities 220 generated by the context assistance server 140 can be ranked. The rank of each activity can indicate a likelihood that the mobile device user is engaged in the activity. The rank can be indicated in various ways, such as order in which the list of likely activities 220 is provided (e.g., most likely to least likely activity). Additionally or alternatively, the rank can include more detailed information, such as a probability associated with a particular activity. The context assistance server 140 can use rankings of activities associated within one or more regions 350 to determine and/or rank the list of likely activities 220. Similarly, the mobile device 110 can use rankings of activities in the list of likely activities 220 to in a context determination (e.g., giving more weight to higher-ranking activities).

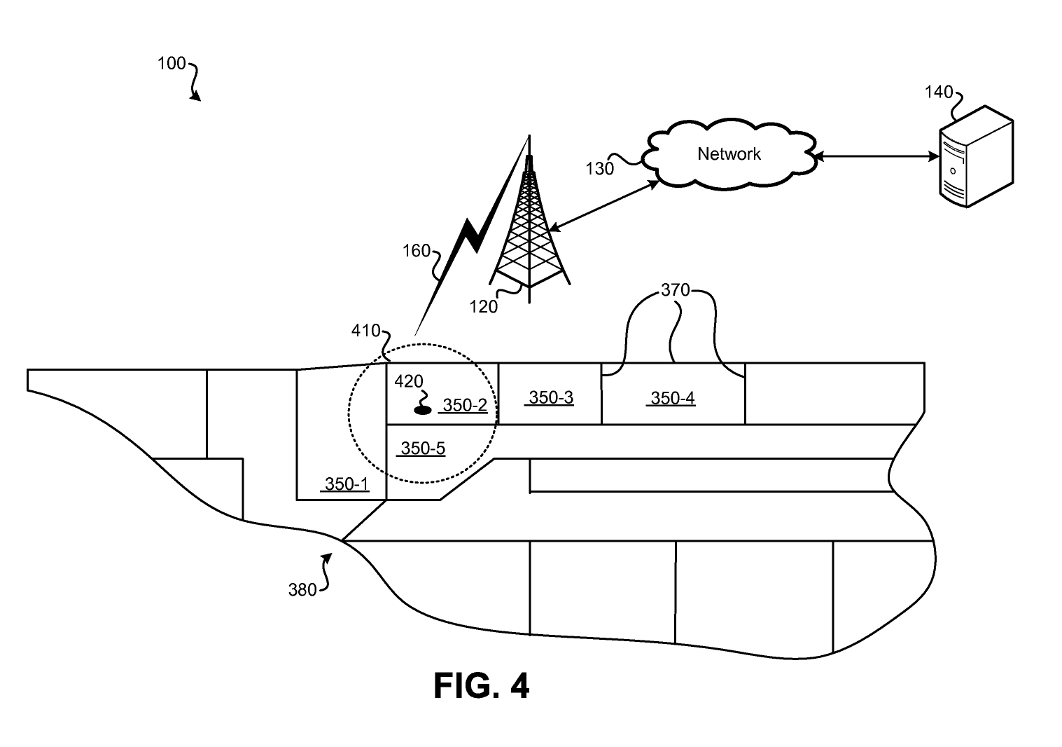

FIG. 4 is a diagram illustrating how a location of a mobile device 110 (not shown) may be imprecise. Such situations may arise in configurations where GPS is not utilized or is otherwise unavailable, and location is derived from triangulation and/or other techniques providing less-accurate location information. In such instances, an approximate location 410 may be determined, where the approximate location 410 includes an area in which the mobile device 110 might be located.

Where location information for the mobile device 110 is approximate, the approximate location 410 may include portions of several regions 350-1, 350-2, 350-5. In these circumstances, the list of likely activities 220 can include activities associated with each region 350-1, 350-2, 350-5 included in the approximate location 410. In other words, the activities associated with all regions 350-1, 350-2, 350-5 included in the approximate location 410 can be included in the list of likely activities 220 created by the context assistance server 140 and provided to the mobile device 110.

The activities associated with all regions 350-1, 350-2, 350-5 included in the approximate location 410 may be combined in several ways. One way to combine the activities can be to give activities that appear in more than one region 350 a higher ranking in the combined list. For example, if activities from regions 350-1, 350-2, and 350-5 are combined, and the activity “exercising” is associated with all three regions, but the activity “sitting” is associated with only region 350-1, then the activity “exercising” can be given a higher ranking in the combined list.

Another way to combine the activities from multiple regions 350 can be to rank activities based on a proximity of the regions to the center 420 of the approximate location 410. Activities in regions closer to the center 420 of the approximate location 410 of the mobile device can be given a higher ranking For example, if the region 350-2 that includes the activity “exercising” is closer to the center 420 of the approximate location 410 than the region 350-5 that includes the activity “sitting,” the activity “exercising” can be given a higher ranking than the activity “sitting” in the combined list.

The creation of the combined list of activities associated with multiple regions 350 can take into account various factors, and can vary depending on desired functionality. For example, an activity's ranking in the combined list can depend on any combination of ranking within a particular region 350, appearance in more than one of the combined regions 350, distance of the region to the center 420 of the approximate location 410 of the mobile device 110, and more. These factors can be weighted differently, and can may be changed and/or updated as desired.

Combining of regions 350 can occur even in instances where more precise location information of the mobile device 110 is known. For instance, many regions 350 can overlap (i.e., they do not need to be mutually exclusive), in which case a mobile device 110 may be located in two regions 350 at the same time. Additionally or alternatively, the context assistance server 140 can utilize geofencing information from more than one source (e.g., different geofencing “maps” that divide the same geographical area differently, based on different factors such as modes of transportation, recreational activities, types of shopping, etc.), in which case regions 350 from different sources may be combined. Other types of combinations are can be made as well.

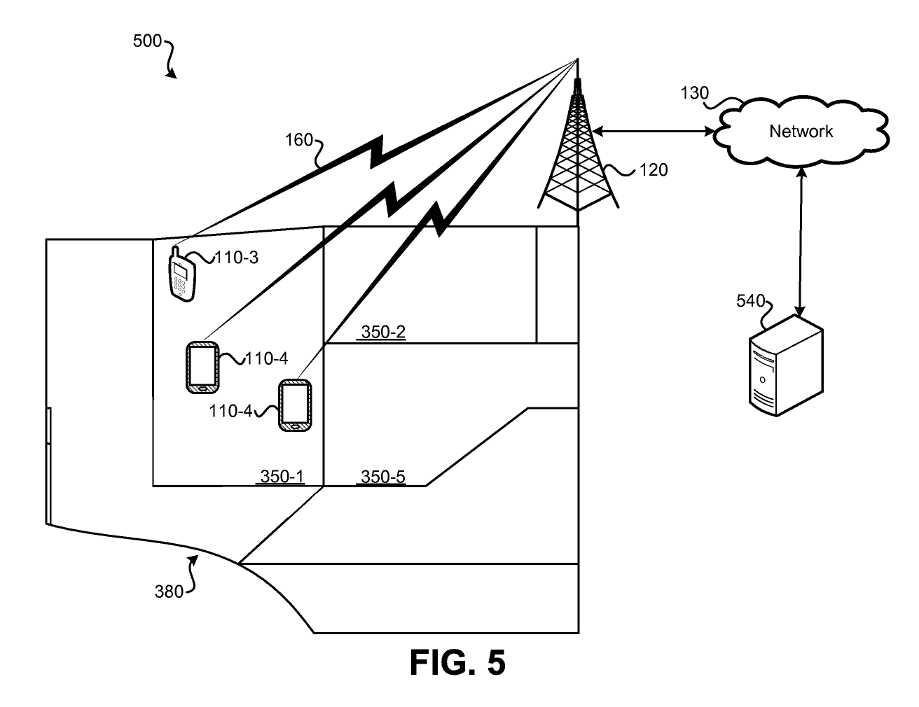

FIG. 5 is a diagram illustrating a system 500 for crowdsourcing context information by sharing information among mobile devices 110 to help facilitate the mobile devices' context determinations. Although location information can be used to facilitate context determinations, additional information can be used, such as sensor data (audio, video, movement, etc.), computation results, and user input. For instance, audio data captured from a microphone on the mobile device can be analyzed to help conclude that the user is in a noisy bar. Movement data captured using a gyroscope and/or accelerometer can be used to conclude that the user is jogging. Video data captured with a camera can be used to conclude that the user is in a park, etc. This additional information can be provided go a context crowd source server 540 that can relay current or prior activity information of other mobile devices 110-2 near a first mobile device 110-1 to help the first mobile device 110-1 in a context determination.

Such sharing of information (including sensor and location information) can be especially beneficial to devices that have little other information from which to make a context determination. For example, a less capable mobile device 110-3 (such as a feature phone) may have few sensors. However, it can benefit from information received from more capable mobile devices 110-4 (such as smart phones) with numerous sensors. Sensor information can be processed by the context crowd source server 540, or relayed directly to the less capable mobile device 110-3 for context determination. Additionally or alternatively, a more capable mobile device 110-4 can make a computation and/or determination regarding context, which can be relayed to the less capable mobile device 110-3. Also, information received from a user of one of the more capable mobile devices 110-4 can be processed and/or relayed to a less-capable mobile device 110-3 for context determination. It will be understood that the use of “less-capable” and “more capable” devices is provided as an example. Mobile devices 110 can also share context-related information with other mobile devices 110 having more, less, or similar capabilities.

In specific example, a first mobile device 110-3 can indicate to a context crowd source server 540 that it wants to make a context determination. The first mobile device 110-3, however, may not have a camera. One or more other mobile devices 110-4 that have cameras, can upload camera information to the context crowd source server 540 to share with the first mobile device 110-3. The camera information can be current, or may be from the past. The other mobile devices 110-4 may be in the same region 350-1 as the first mobile device 110-3, or they may have been in the same region 350-1 in the past, when the camera information was uploaded to the context crowd source server 540. The camera information can be relayed to the first mobile device 110-3 by the context crowd source server 540, or the context crowd source server 540 may process the information and provide separate information to the first mobile device 110-3, such as a likelihood that a user of the first mobile device 110-3 is engaged in one or more activities, given the camera information received from the other mobile devices 110-4. Additionally or alternatively, the context crowd source server 540 may be communicatively linked, or integrated into, the context assistance server 140, in which case the camera information can be used to influence and/or alter rankings of a list of likely activities 220 provided to the first mobile device 110-3. If one or more of the other mobile devices 110-4 has made a context determination, such as “attending a concert,” for example, the context determination may be shared with the first mobile device 110-3, in which case the first mobile device 110-3 can weigh more heavily the likelihood that a user of the first mobile device 110-4 is also “attending a concert.”

Alternative configurations can allow sharing of information from user input for context determination. If one of the other mobile devices 110-4 receives sensor information or user input indicating that the user may be engaged in a particular activity, the information can be relayed to the first mobile device 110-3 to assist in context determination. Additionally or alternatively, the user may indicate that a context determination made by a mobile device 110 is incorrect. This information can be provided to the context crowd source server 540 to improve future context determination.

Numerous variations on the system 500 can be made. For example, as indicated above, the context crowd source server 540 may be communicatively linked, or integrated into, the context assistance server 140 to provide both context assistance and crowdsourcing information to mobile devices 110. Additionally or alternatively, mobile devices 110 may be able to communicate and share information directly through wireless and/or wired means, such as wireless networks (radio frequency (RF) communications, infrared ports, etc.), physical cables, and/or other physical connections. Also, the context crowd source server 540 can enable collection zones, which can be the same as (or different from) the geofenced regions 350 of the context assistance server 140. The context crowd source server 540 can explicitly ask for context information (e.g., location and/or sensor data) from particular mobile devices 110 in a given collection zone or when mobile devices 110 identify to a trigger event (e.g., noise level is above a particular threshold).

A context assistance server 140 can also benefit from the information received by the context crowd source server 540. When mobile devices 110 make and share context determinations related to a particular region 350, the context assistance server 140 can adjust the activities and/or activity rankings associated with the particular region. For example, mobile devices 110 may determine (through user input or other information) that a user is engaged in a new activity that is not associated with a particular region 350, and the context crowd source server 540 can receive this input and share it with the context assistance server 140, which can determine whether to include the new activity in the list of activities associated with the particular region 350. Similarly, rankings corresponding to activities associated with the particular region 350 can be adjusted based on the context determinations of mobile devices 110.

As the context assistance server 140 and/or context crowd source server 540 adjusts to input from mobile devices 110, they can share this “learning” with the mobile devices by updating context recognition models used by the mobile devices 110 themselves. For example, if a server determines that enough users have indicated that a context determination made by mobile devices 110 in response to certain sensor and/or location information is incorrect, the server can share this information with the mobile devices 110 so that the context determination models can be adjusted accordingly. Alternatively, the server can use the information to adjust a model, which it provides to the mobile devices 110 for download. Also, as the context assistance server 140 receives shared information from mobile devices 110 through the context crowd source server 540, it can update the activities and rankings associated with various regions 350, which can lead to faster, more accurate context determination by the mobile devices 110. Also, as a mobile device 110 receives shared information from other mobile devices 110 and makes context determinations, it can associate its own sensor and/or location information with a particular context determination, which can lead to faster, more accurate context determinations the next time the mobile device receives similar sensor and/or location information from its own sensors.

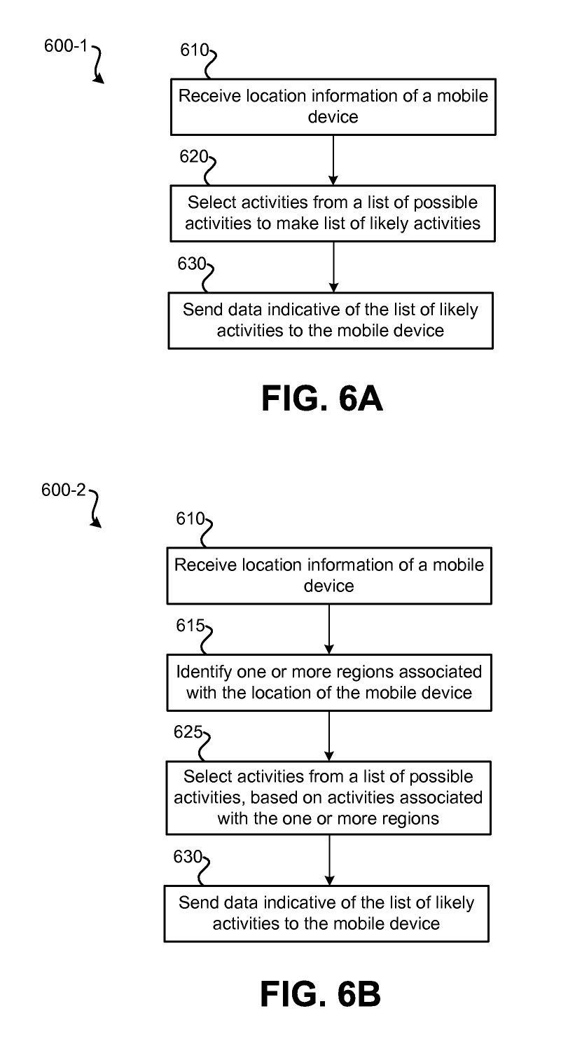

FIG. 6A is a simplified flow diagram illustrating a basic method 600-1 of facilitating context determination. The method 600, which can be performed by a server or other computing device, is provided as an example only, and is not limiting. It starts at block 610, where location information of a mobile device 110 is received. As stated above, this can include GPS or other information from the mobile device 110. Additionally or alternatively, location information can be determined by a mobile carrier network or other service provider, in which case the origin of the mobile device's location information may not be the mobile device.

At block 620, activities from a list of possible activities are selected to make a list of likely activities 220. The selected activities can be chosen based on various factors, including location and/or sensor data provided by the mobile device 110 or received from other mobile devices 110. Moreover, the selected activities may be ranked to indicate a likelihood (absolute or relative) of a user engaging in each of the selected activities. At block 630, data indicative of the list of likely activities 220 (including rank, if the selected activities have been ranked) is sent to the mobile device 110. The data can include names of the activities on the list of likely activities 220, or it may include identifiers 224 (e.g., index numbers) of the activities on the list of likely activities 220. The mobile device 110 can then utilize this data to make a context determination.

FIG. 6B is simplified flow diagram illustrating another basic method 600-2 of facilitating context determination. The method 600-2 of FIG. 6B includes blocks similar to the method 600-1 of FIG. 6A. However, the method 600-2 includes a block 615, at which one or more regions associated with the location of the mobile device 110 are identified. Additionally, at block 625, the selection of activities from a list of possible activities 210 is based on activities associated with the one or more regions. Here, too, the activities can be ranked. As mentioned above, where a mobile device 110 has an approximate location 410, regions can be combined. Moreover, any ranking associated with activities on a combined list may be adjusted due to various factors, such as whether an activity is found on two or more of the regions 350 that were combined and/or how close a region 350 is to the center of the approximate location 410.

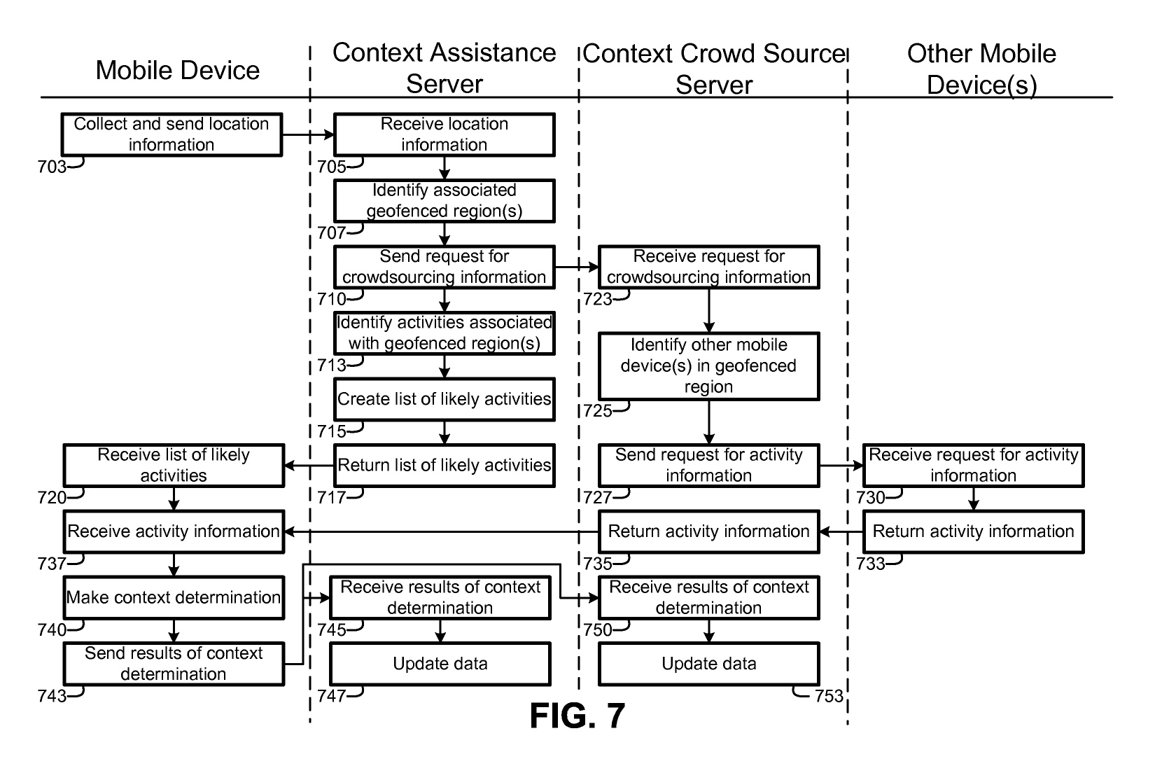

FIG. 7 is a swim-lane diagram that illustrates the interaction between a first mobile device 110-3, context assistance server 140, context crowd source server 540, and other mobile device(s) 110-4, according to one configuration. At block 703, the first mobile device 110-3 collects and sends location information to the context assistance server 140, which receives the location information at block 705. With the location information, the context assistance server 140 can identify geofenced region(s) 350 associated with the location. At block 710, the context assistance server 140 can send a request for crowdsourcing information to the context crowd source server 540.

As mentioned above, geofenced region(s) 350 can be associated with one or more activities. The context assistance server 140 can identify the one or more activities at block 713, and at block 715, create a list of likely activities 220, which can be chosen from a list of possible activities 210 and/or the one or more activities associated with the geofenced region(s) 350. The list of likely activities 220 can then be returned to the first mobile device 110-3, which receives the list of likely activities at block 720.

Meanwhile, at block 723, the context crowd source server 540 can receive the request for crowdsourcing information. The request can include information about any geofenced region(s) 350 identified by the context assistance server 140 at block 707. Additionally or alternatively, the request may simply provide location information for the mobile device 110 with which the context crowd source server 540 can determine a reference area within which the context crowd source server 540 can solicit context information. At block 725, the context crowd source server 540 identifies other mobile device(s) 110-4 in the geofenced region 350 (and/or reference area), and at block 727, the context crowd source server 540 sends a request to the other mobile device(s) 110-4 for activity information.

As discussed above, activity information can be solicited from other mobile device(s) 110-4 currently in the geofenced region 350, or past information can be retrieved. For example, the context crowd source server 540 may include a database that includes activity information for a particular geofenced region. The activity information can include information received from other mobile device(s) 110-4 when the other mobile device(s) 110-4 were in the particular geofenced region 350. Additionally or alternatively, the other mobile device(s) 110-4, which may not be in the particular geofenced region 350 at the time of the request of block 727, may store activity information related to the particular geofenced region 350 that may have been collected when the other mobile device(s) 110-4 were in the particular geofenced region 350. In this case, the other mobile device(s) 110-4 can provide the context crowd source server 540 with the relevant activity information for the geofenced region 350. As discussed above, relevant activity information can include, among other things, sensor information from the other mobile device(s) 110-4, information received from a user of one of the other mobile device(s) 110-4, and/or a computation/determination regarding an activity related to the a user of one of the other mobile device(s) 110-4 (e.g., a context determination).

At block 733, the other mobile device(s) 110-4 return the requested activity information, which is relayed by the context crowd source server 540 back to the first mobile device 110-3 at block 735. The first mobile device 110-3 receives the activity information at block 737. It can be noted that the context crowd source server 540 and/or the first mobile device 110-3 can store the activity information for later use in context determination.

With the list of likely activities 220 and the activity information, the first mobile device 110-3 can make a context determination at block 740. As indicated earlier, the context determination can comprise selecting one or more activities from the list of likely activities 220 in which the mobile device user is likely engaged. The context determination can also include a determination that the mobile device user is likely engaged in an activity not on the list of likely activities 220, based, at least in part, on the activity information received from the context crowd source server 540.

Additional steps can be taken to help the context assistance server 140 and/or the context crowd source server 540 “learn” from the context determination of the first mobile device 110-3. At block 743, for example, the first mobile device 110-3 can send results of the context determination back to either or both of the context assistance server 140 and/or the context crowd source server 540. At blocks 745, 750 and 747, 750, the servers receive these results and update data accordingly.

Numerous variations can be made to the process shown in FIG. 7. For example, other mobile device(s) 110-4 may be equipped to communicate directly to the first mobile device 110-3 making the context determination. Also, in addition or as an alternative to providing the activity information to the first mobile device 110-3 for a context determination, the activity information can be provided to the context assistance server 140, which can adjust the list of likely activities 220 accordingly (e.g., altering the activities that appear on the list, changing the ranking of the activities, etc.).

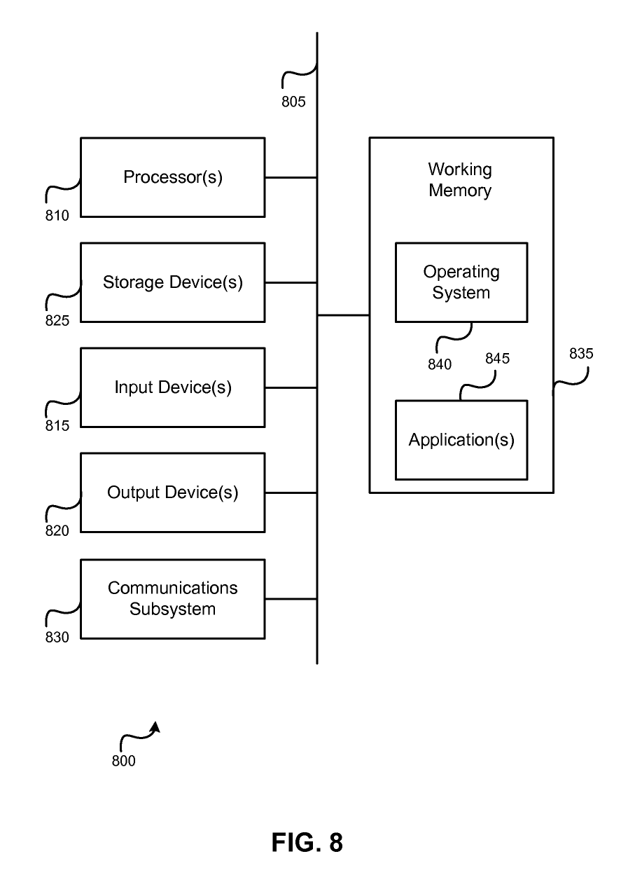

A computer system as illustrated in FIG. 8 may be incorporated as part of the previously described computerized devices. For example, computer system 800 can represent some of the components of the mobile devices 110 and/or the servers 140, 540 discussed in this application. FIG. 8 provides a schematic illustration of one embodiment of a computer system 800 that can perform the methods provided by various other embodiments, as described herein, and/or can function as the host computer system, a remote kiosk/terminal, a point-of-sale device, a mobile device, and/or a computer system. FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805 (or may otherwise be in communication, as appropriate). The hardware elements may include one or more processors 810, including without limitation one or more general-purpose processors and/or one or more special-purpose processors (such as digital signal processing chips, graphics acceleration processors, and/or the like); one or more input devices 815, which can include without limitation a mouse, a keyboard and/or the like; and one or more output devices 820, which can include without limitation a display device, a printer and/or the like.

The computer system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or similar communication interfaces. The communications subsystem 830 may permit data to be exchanged with a network (such as the network described below, to name one example), other computer systems, and/or any other devices described herein. In many embodiments, the computer system 800 will further comprise a non-transitory working memory 835, which can include a RAM or ROM device, as described above.

The computer system 800 also can comprise software elements, shown as being currently located within the working memory 835, including an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 825 described above. In some cases, the storage medium might be incorporated within a computer system, such as computer system 800. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an activity selection subsystem configured to provide some or all of the features described herein relating to the selection of activities by a context assistance server 140 can comprise hardware and/or software that is specialized (e.g., an application-specific integrated circuit (ASIC), a software method, etc.) or generic (e.g., processor(s) 810, applications 845, etc.) Further, connection to other computing devices such as network input/output devices may be employed.

Some embodiments may employ a computer system (such as the computer system 800) to perform methods in accordance with the disclosure. For example, some or all of the procedures of the described methods may be performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another computer-readable medium, such as one or more of the storage device(s) 825. Merely by way of example, execution of the sequences of instructions contained in the working memory 835 might cause the processor(s) 810 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 800, various computer-readable media might be involved in providing instructions/code to processor(s) 810 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 825. Volatile media include, without limitation, dynamic memory, such as the working memory 835. Transmission media include, without limitation, coaxial cables, copper wire and fiber optics, including the wires that comprise the bus 805, as well as the various components of the communications subsystem 830 (and/or the media by which the communications subsystem 830 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals and/or the like, are all examples of carrier waves on which instructions can be encoded, in accordance with various embodiments of the invention.

The communications subsystem 830 (and/or components thereof) generally will receive the signals, and the bus 805 then might carry the signals (and/or the data, instructions, etc. carried by the signals) to the working memory 835, from which the processor(s) 805 retrieves and executes the instructions. The instructions received by the working memory 835 may optionally be stored on a non-transitory storage device 825 either before or after execution by the processor(s) 810.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. One or more servers for utilizing a data network to facilitate a determination of an activity related to a user of a mobile device, the one or more servers comprising:
a communication interface communicatively coupled with the data network and configured to receive, from the mobile device, location information indicative of a location of the mobile device;
a storage medium configured to store data indicative of a first plurality of activities; and
an activity selection subsystem communicatively coupled with the storage medium and communication interface and configured to select, from the first plurality of activities, a second plurality of possible activities based on the location of the mobile device, wherein:
the second plurality of possible activities comprises a subset of the first plurality of activities; and
the data indicative of the second plurality of possible activities is sent to the mobile device via the communication interface.

2. The one or more servers of claim 1, wherein the activity selection subsystem comprises one or more processors.

3. The one or more servers of claim 1, wherein the activity selection subsystem is configured to:
determine a rank for each activity of the second plurality of possible activities, wherein the rank for each activity of the second plurality of possible activities is indicative of a likelihood that the user of the mobile device is engaged in the activity; and
provide the rank for each activity of the second plurality of possible activities to the mobile device.

4. The one or more servers of claim 1, further comprising a database communicatively coupled with the activity selection subsystem and configured to store information defining one or more regions associated with the location of the mobile device.

5. The one or more servers of claim 4, wherein the activity selection subsystem is configured to select the second plurality of possible activities based, at least in part, on one or more activities associated with each of the one or more regions.

6. The one or more servers of claim 5, wherein the database is configured to store the one or more activities associated with each of the one or more regions.

7. The one or more servers of claim 6, wherein the activity selection subsystem is configured to determine a rank for each activity of the second plurality of possible activities, wherein:
the rank for each activity of the second plurality of possible activities is indicative of a likelihood that the user of the mobile device is engaged in the activity;
the location of the mobile device is an approximate location that comprises an area in which the mobile device might be located; and
the rank for the one or more activities associated with each of the one or more regions is based, at least in part, on a proximity of the one or more regions to a center of the area.

8. The one or more servers of claim 1, wherein the one or more servers are configured to include, in the data indicative of the second plurality of possible activities, a unique identifier for each activity of the second plurality of possible activities that corresponds with an activity of the first plurality of activities.

9. The one or more servers of claim 1, wherein:
the mobile device comprises a first mobile device; and
the communication interface is configured to:
receive activity information from one or more additional mobile devices, based, at least in part, on the location of the one or more additional mobile devices; and
send, to the first mobile device, the activity information, wherein the activity information includes at least one item from the list consisting of:
information from a sensor of the one or more additional mobile devices,
information received from a user of the one or more additional mobile devices, and
a computation regarding the activity related to the user of the one or more additional mobile devices.

10. The one or more servers of claim 1, wherein:
the communication interface is configured to receive activity information from the mobile device wherein the activity information includes at least one item from the list consisting of:
information from one or more sensors of the mobile device,
information received from the user of the mobile device, and
a computation regarding the activity related to the user of the mobile device; and
the activity selection subsystem is configured to make a determination regarding the activity related to the user of the mobile device.

11. The one or more servers of claim 10, wherein the activity selection subsystem is configured to modify a set of activities associated with a region in which the mobile device is located based, at least in part, on the determination regarding the activity related to the user of the mobile device.

12. A method of facilitating a determination of an activity related to a user of a mobile device, the method comprising:
receiving, from the mobile device, location information indicative of a location of the mobile device;
selecting, from a first plurality of activities, a second plurality of possible activities based on the location of the mobile device, wherein the second plurality of possible activities comprises a subset of the first plurality of activities; and
sending, to the mobile device, data indicative of the second plurality of possible activities.

13. The method of claim 12, further comprising:
determining a rank for each activity of the second plurality of possible activities, wherein the rank for each activity of the second plurality of possible activities is indicative of a likelihood that the user of the mobile device is engaged in the activity; and
providing the rank for each activity of the second plurality of possible activities to the mobile device.

14. The method of claim 12, wherein selecting the second plurality of possible activities further comprises:
identifying one or more regions associated with the location of the mobile device; and
selecting the second plurality of possible activities based, at least in part, on one or more activities associated with each of the one or more regions.

15. The method of claim 14, further comprising determining a rank for each activity of the second plurality of possible activities, wherein:
the rank for each activity of the second plurality of possible activities is indicative of a likelihood that the user of the mobile device is engaged in the activity;
the location of the mobile device is an approximate location that comprises an area in which the mobile device might be located; and
the rank for the one or more activities associated with each of the one or more regions is based, at least in part, on a proximity of the one or more regions to a center of the area.

16. The method of claim 12, wherein:
the data indicative of the second plurality of possible activities comprises a unique identifier for each activity of the second plurality of possible activities; and
the unique identifier corresponds with an activity of the first plurality of activities.

17. The method of claim 12, wherein the mobile device comprises a first mobile device, further comprising:
receiving activity information from one or more additional mobile devices, based, at least in part, on the location of the one or more additional mobile devices; and
sending, to the first mobile device, the activity information;
wherein the activity information includes at least one item from the list consisting of:
information from a sensor of the one or more additional mobile devices,
information received from a user of the one or more additional mobile devices, and
a computation regarding the activity related to the user of the one or more additional mobile devices.

18. The method of claim 17, wherein the activity information from the one or more additional mobile devices includes sensor information from at least one type of sensor the first mobile device does not have.

19. The method of claim 12, further comprising:
receiving activity information from the mobile device wherein the activity information includes at least one item from the list consisting of:
information from one or more sensors of the mobile device,
information received from the user of the mobile device, and
a computation regarding the activity related to the user of the mobile device; and
making a determination regarding the activity related to the user of the mobile device.

20. The method of claim 19 further comprising modifying a set of activities associated with a region in which the mobile device is located based, at least in part, on the determination regarding the activity related to the user of the mobile device.

21. A computer program product residing on a non-transitory processor-readable medium and comprising processor-readable instructions configured to cause a processor to:
receive, from a mobile device, location information indicative of a location of the mobile device;
select, from a first plurality of activities, a second plurality of possible activities based on the location of the mobile device, wherein the second plurality of possible activities comprises a subset of the first plurality of activities; and
send, to the mobile device, data indicative of the second plurality of possible activities.

22. The computer program product of claim 21, wherein the processor-readable instructions further are configured to cause the processor to:
determine a rank for each activity of the second plurality of possible activities, wherein the rank for each activity of the second plurality of possible activities is indicative of a likelihood that the a of the mobile device is engaged in the activity; and
provide the rank for each activity of the second plurality of possible activities to the mobile device.

23. The computer program product of claim 21, wherein selecting the second plurality of possible activities further comprises:
identifying one or more regions associated with the location of the mobile device; and
selecting the second plurality of possible activities based, at least in part, on one or more activities associated with each of the one or more regions.

24. The computer program product of claim 23, wherein the processor-readable instructions further are configured to cause the processor to determine a rank for each activity of the second plurality of possible activities, wherein:
the rank for each activity of the second plurality of possible activities is indicative of a likelihood that a user of the mobile device is engaged in the activity;
the location of the mobile device is an approximate location that comprises an area in which the mobile device might be located; and
the rank for the one or more activities associated with each of the one or more regions is based, at least in part, on a proximity of the one or more regions to a center of the area.

25. The computer program product of claim 21, wherein:
the data indicative of the second plurality of possible activities comprises a unique identifier for each activity of the second plurality of possible activities; and
the unique identifier corresponds with an activity of the first plurality of activities.

26. The computer program product of claim 21, wherein the mobile device comprises a first mobile device and the processor-readable instructions further are configured to cause the processor to:
receive activity information from one or more additional mobile devices, based, at least in part, on the location of the one or more additional mobile devices; and
send, to the first mobile device, the activity information;
wherein the activity information includes at least one item from the list consisting of:
information from a sensor of the one or more additional mobile devices,
information received from a user of the one or more additional mobile devices, and
a computation regarding the activity related to a user of the one or more additional mobile devices.

27. The computer program product of claim 26, wherein the activity information from the one or more additional mobile devices includes sensor information from at least one type of sensor the first mobile device does not have.

28. The computer program product of claim 21, wherein the processor-readable instructions further are configured to cause the processor to:
receive activity information from the mobile device wherein the activity information includes at least one item from the list consisting of:
information from one or more sensors of the mobile device,
information received from a user of the mobile device, and
a computation regarding the activity related to the user of the mobile device; and
make a determination regarding the activity related to the user of the mobile device.

29. The computer program product of claim 28, wherein the processor-readable instructions further are configured to cause the processor to modify a set of activities associated with a region in which the mobile device is located based, at least in part, on the determination regarding the activity related to the user of the mobile device.

30. One or more servers for facilitating a determination of an activity related to a user of a mobile device, the one or more servers comprising:
means for receiving, via a network, location information indicative of a location of the mobile device;
means for selecting, from a first plurality of activities, a second plurality of possible activities based on the location of the mobile device, wherein the second plurality of possible activities comprises a subset of the first plurality of activities; and
means for sending, to the mobile device, data indicative of the second plurality of possible activities.

31. The one or more servers of claim 30, further comprising:
means for determining a rank for each activity of the second plurality of possible activities, wherein the rank for each activity of the second plurality of possible activities is indicative of a likelihood that the user of the mobile device is engaged in the activity; and
means for providing the rank for each activity of the second plurality of possible activities to the mobile device.

32. The one or more servers of claim 30, wherein the means for selecting the second plurality of possible activities further comprises:
means for identifying one or more regions associated with the location of the mobile device; and
means for selecting the second plurality of possible activities based, at least in part, on one or more activities associated with each of the one or more regions.

33. The one or more servers of claim 32, further comprising means for determining a rank for each activity of the second plurality of possible activities, wherein:
the rank for each activity of the second plurality of possible activities is indicative of a likelihood that the user of the mobile device is engaged in the activity;
the location of the mobile device is an approximate location that comprises an area in which the mobile device might be located; and
the rank for the one or more activities associated with each of the one or more regions is based, at least in part, on a proximity of the one or more regions to a center of the area.

34. The one or more servers of claim 30, wherein:
the data indicative of the second plurality of possible activities comprises a unique identifier for each activity of the second plurality of possible activities; and
the unique identifier corresponds with an activity of the first plurality of activities.

35. The one or more servers of claim 30, wherein the mobile device comprises a first mobile device, further comprising:
means for receiving activity information from one or more additional mobile devices, based, at least in part, on the location of the one or more additional mobile devices; and
means for sending, to the first mobile device, the activity information, wherein the activity information includes at least one item from the list consisting of:
information from a sensor of the one or more additional mobile devices,
information received from a user of the one or more additional mobile devices, and
a computation regarding the activity related to the user of the one or more additional mobile devices.

36. The one or more servers of claim 35, wherein the activity information from the one or more additional mobile devices includes sensor information from at least one type of sensor the first mobile device does not have.

37. The one or more servers of claim 30, further comprising:
means for receiving activity information from the mobile device wherein the activity information includes at least one item from the list consisting of:
information from one or more sensors of the mobile device,
information received from the user of the mobile device, and
a computation regarding the activity related to the user of the mobile device; and
means for making a determination regarding the activity related to the user of the mobile device.

38. The one or more servers of claim 37 further comprising means for modifying a set of activities associated with a region in which the mobile device is located based, at least in part, on the determination regarding the activity related to the user of the mobile device.
